(19) United States
(12) Patent Application Publication
(10) Pub. No.: US 2025/0320033 A1
(43) Pub. Date: Oct. 16, 2025

(54) STORAGE DEVICE FOR SMALL PIECE GOODS, KIT FOR MAKING A STORAGE STATION FOR SMALL PIECE GOODS STORABLE AND METHOD FOR STORING STORAGE STATIONS

(71) Applicant: BECTON DICKINSON ROWA GERMANY GMBH, Kelberg (DE)

(72) Inventors: Hardy SCHMIDT-ELLINGER, Gerolstein (DE); Thomas JÜNGER, Oberelz (DE)

(21) Appl. No.: 19/173,461

(22) Filed: Apr. 8, 2025

(30) Foreign Application Priority Data
Apr. 12, 2024 (EP) 24169909.9

(51) Int. Cl. B65D 25/22

(52) U.S. Cl. CPC B65D 25/22

(57) ABSTRACT

The invention relates to a storage device for small piece goods, a kit for making a storage station storable, and a method for storing storage stations. The storage device comprises a storage station for small piece goods with a housing and a holding device, wherein the housing has an outer maximum housing contour, with a base structure, arranged below the housing, with two side regions and two end regions in each case. The storage device further comprises an adapter means with at least two contact means which are detachably arranged on the base structure and which are designed such that each contact means, in the fastened state, provides a contact portion adjacent to the side regions, which contact portions are designed and aligned such that the contact portions can be gripped by clamping jaws of the jaw gripper.

The invention relates to a storage device for small piece goods, a kit for making a storage station storable in a picking device operated with a jaw gripper, and a method for storing storage stations.

Modern blister machines, as disclosed, for example, in WO 2013/034504 A1, comprise, depending upon the level of expansion, several hundred storage and dispensing stations. In these, for example, several portions of a drug or individual portions of a dietary supplement of a certain type are stored, and individual portions are dispensed on demand. With the blister machine, the portions stored in the storage and dispensing stations are compiled and blistered patient-specifically according to the administration times prescribed by the doctor. How exactly the drug portions or individual portions of a food supplement stored in the storage and dispensing stations are blistered is disclosed in the aforementioned publication, but is not relevant for the present invention.

The storage and dispensing stations used in a blister machine usually comprise two groups of components, viz., a storage station in which the drug portions or individual portions of a dietary supplement are stored, and a dispensing station via which the storage station is controlled. To make refilling and cleaning the storage stations easier, they are usually mounted removably on the dispensing stations. The dispensing stations usually remain on the blister machine when the storage stations are refilled or cleaned. However, they are usually not formed as one piece with the blister machine, but are also detachably fastened to a frame of the blister machine, e.g., screwed, and coupled to a control device of the blister machine.

Due to the way in which the drug portions or individual portions of a food supplement stored in a storage and dispensing station (hereafter referred to as small piece goods, wherein this term is intended to include all small items that can be stored in such a station and separated with it) are separated (individual components of the storage station must be adapted to the size of the small piece goods to be separated), a blister machine is usually operated with a number of storage stations that far exceeds the number of dispensing stations of the blister machine. The storage stations that are not currently in operation must be stored, regardless of whether they are already filled or not. For this purpose, they are usually placed in a shelving system by the user. This type of storage is complex and not space-optimized.

The present invention is based upon the object of making the known storage stations storable and of providing a method for storing storage stations which are not storable per se.

A large number of blister machines are known from the prior art that work with the aforementioned storage and dispensing stations. Due to the design of the blister machines and the lack of standardization requirements, the storage stations used by the various manufacturers are not uniform, and it is not possible to handle all of these storage stations with an actuator of the same type; the shapes or contours of the storage stations are too inconsistent for this.

The object is therefore achieved by a storage device for small piece goods, wherein the storage device is suitable for storage in a picking device. The storage device comprises two main assemblies, viz., any storage station (which cannot be stored automatically) and an adapter means, which are detachably connected to one another, wherein the adapter means is adapted and designed such that the combination of the two main assemblies provides an automatically storable storage device.

In detail, the object is achieved by a storage device for storage in a picking device, operated with a jaw gripper, with a plurality of horizontal storage locations, having a storage station for small piece goods with i) a housing with an upper housing portion, a lower housing portion, and a base plate with a discharge opening, wherein the upper and lower housing portions define a receiving space with a lower, inner circular-cylindrical receiving space portion and an upper receiving space portion extending above it, and with a separating device, arranged in the lower circular-cylindrical receiving space portion, and a holding device, wherein the housing has an outer maximum housing contour, and with ii) a base structure arranged below the housing and supporting the housing, with two opposite side regions and two opposite end regions in each case, wherein the side regions and the end regions together define a base structure contour, further having an adapter means with at least two contact means which are detachably arranged on the base structure and which are designed such that each contact means, in the fastened state, provides a contact portion adjacent to the side regions, wherein the contact portions are designed and aligned such that the contact portions can be gripped by clamping jaws of the jaw gripper.

According to the invention, an existing and known storage station is combined with an adapter means that provides contact portions that are designed such that they can be gripped by the clamping jaws of a jaw gripper, whereby the storage station as such can be stored automatically. The exact design of the adapter means depends upon the design of the storage station itself. It is essential that the contact means of the adapter means are adapted or designed according to the base structure of the storage station, so that grippable contact portions are provided. Typically, the contact means will be designed in such a way that parallel, vertical contact portions are provided. However, depending upon the exact design of the clamping jaws of the jaw gripper, this is not absolutely necessary; what is essential is that the contact portions enable the automatic handling of the storage device.

As already mentioned, the exact design of the adapter means depends in particular upon the base structure of the storage station which is to be made storable with the adapter means. For example, it is conceivable that the adapter means have “only” two structurally separate contact means which are designed according to the invention and are, for example, detachably fastened to the side regions of the base structure and accordingly provide the contact portions.

In order to support the positioning of the adapter means and its fastening, a preferred embodiment provides that the adapter means be U-shaped and have a base portion to which the contact means are fastened.

According to the invention, the adapter means is detachably fastened to the base structure. The detachable fastening of the adapter means to the base structure of the storage station can be done in a variety of ways. In one embodiment, it is provided that at least one contact means have an elastic clamping portion, and the contact means and the at least one clamping portion be arranged and designed such that the adapter means is detachably fastened to the base structure by means of a frictional connection. In this embodiment, it is therefore provided that the base structure of the storage station be clamped by the contact means of the adapter means and thus the connection be made via frictional connection. The elastic clamping portion must be designed here in such a way that the clamping force is sufficient to move the storage device over the contact portions.

Alternatively, for the detachable fastening of the adapter means, it can be provided that at least one contact means have, at its end portion facing away from the base portion, an inward-facing, at least partially elastic gripping portion which is designed such that the adapter means is detachably fastened to the base structure via the base portion and the gripping portion by means of a clamping force.

A further alternative provides that each contact means have a first fastening means and each side region have a second fastening means, wherein the first fastening means and the second fastening means are coordinated with one another in such a way that the contact means are detachably fastened to the base structure. The exact design of the fastening means is not important. It is conceivable, for example, that a hole simply be provided in the side regions as a second fastening means, into which a locking lug of the first fastening means engages.

As explained above, the object of the present invention is to provide an automatically storable storage device that can be moved with a jaw gripper of a picking device. With modern picking devices, there is a tendency to increase the storage depth of the storage locations as much as possible so that a plurality of, for example, drug packages can be stored one after the other. For this purpose, it may be advantageous to arrange a plurality of (identical) drug packages (hereafter referred to as piece goods) on a deposit region of a storing device of the picking device already during storing, to move them together into the picking device, and to grip them together with the jaw gripper. Known storage stations are usually designed in such a way that they have an upper housing portion that defines an upper receiving space portion intended for the storage of small piece goods. Underneath, there is usually a housing portion which is circular-cylindrical on the inside and in which the separating device is arranged. Below this housing portion, there is a base structure that supports the housing. Accordingly, a storage station usually does not have a cuboid shape, but, rather, a vertically tapering outer contour. It is common for the contour of the base structure to be “smaller” than the maximum outer housing contour, meaning that the housing protrudes outwards beyond the base structure at least in portions. This is especially true for the end regions of the storage station. If a theoretical vertical contact surface is applied to the outer maximum housing contour on the one hand, and the end regions of the base structure contour on the other, a gap results between the contact surfaces at the “front” and/or “rear” of known storage stations. If the storage stations are arranged one after the other so that the housings touch each other, a gap is created between the base structures of the two storage stations. If it were theoretically possible to move the two storage stations together, this could result in the rear of the two storage stations becoming upright and possibly hindering further movement.

In order to avoid a corresponding behavior in the storage devices according to the invention, it is provided in a preferred embodiment that the adapter means have at least one contour compensation portion which, in the fastened state, is arranged in an end region of the base structure and which is designed such that an adapter means contour in the region of the end regions of the base structure is vertically adapted to the maximum housing contour. The at least one contour compensation portion thus ensures that the aforementioned gap is not present and that two (or more) storage devices arranged one after the other can be moved together with no problem.

The object is further achieved by a kit for making a storage station for small piece goods storable in a picking device operated with a jaw gripper, wherein the kit comprises: a storage station for small piece goods with a housing with an upper housing portion, a lower housing portion, and a base plate with a discharge opening, wherein the upper and lower housing portions define a receiving space with a lower, inner circular-cylindrical receiving space portion and an upper receiving space portion extending above it, and with a separating device, arranged in the lower circular-cylindrical receiving space portion, and a holding device, wherein the housing has an outer maximum housing contour, and with a base structure arranged below the housing and supporting the housing, with two opposite side regions and two opposite end regions in each case, wherein the side regions and the end regions together define a base structure contour; and an adapter means for releasably fastening to the base structure of the storage station, wherein the adapter means comprises two contact means, each with a contact portion.

According to the invention, the contact means are designed such that each contact means is arranged adjacent to the side regions in the fastened state, wherein the contact portions are designed such that the contact portions can be gripped by clamping jaws of a jaw gripper in the fastened state of the adapter means.

The kit can be further developed in a plurality of preferred embodiments, as described below. Unless technical advantages are mentioned, these correspond to those of the corresponding embodiments of the storage device.

Preferably, the adapter means is U-shaped and has a base portion to which the contact means are fastened. The at least one contact means can preferably have an elastic clamping portion, and the contact means and the at least one clamping portion are arranged and designed such that the adapter means is releasably fastened to the base structure by means of a frictional connection. Alternatively, it can be provided that at least one contact means have, at its end portion facing away from the base portion, an inward-facing, at least partially elastic gripping portion which is designed such that the adapter means is detachably fastened to the base structure via the base portion and the gripping portion by means of a clamping force.

Furthermore, it can alternatively be provided that each contact means have a first fastening means and each side region have a second fastening means, wherein the first fastening means and the second fastening means are coordinated with one another in such a way that the contact means are detachably fastened to the base structure.

In order to avoid the aforementioned gap, it is provided that the adapter means have a contour compensation portion which can be arranged in an end region of the base structure and is designed such that an adapter means contour in the fastened state is vertically adapted to the maximum housing contour in the region of the end regions of the base structure.

According to the invention, a method for storing storage stations in a picking device with a plurality of horizontal storage locations, a storing device, and a jaw gripper is also proposed, wherein a storage station to be stored is provided with a housing with an outer maximum housing contour and with a base structure arranged below the housing and supporting the housing, with two opposite side regions and two opposite end regions in each case, wherein the side regions and the end regions together define a base structure contour; an adapter means with at least two contact means is determined and provided, wherein each contact means comprises a contact portion, wherein the adapter means is determined such that the contact means are designed such that the fixed adapter means is detachably fastened to the base structure of the storage stations to be stored via the contact means, and the contact portions can be gripped by clamping jaws of a jaw gripper; the adapter means is detachably fastened to the base structure of the storage stations to be stored, thus providing a storage device that can be gripped with the jaw gripper; the grippable storage device is arranged in a deposit region of the storing device; the grippable storage device arranged in the deposit region is moved with the storing device in a storage direction, and the grippable storage device is gripped with the jaw gripper at the contact portions and moved to a horizontal storage location.

In the following, preferred embodiments of the storage device for small piece goods according to the invention, the kit for making a storage station for small piece goods storable, and a method for storing storage stations are described with reference to the drawing, in which:

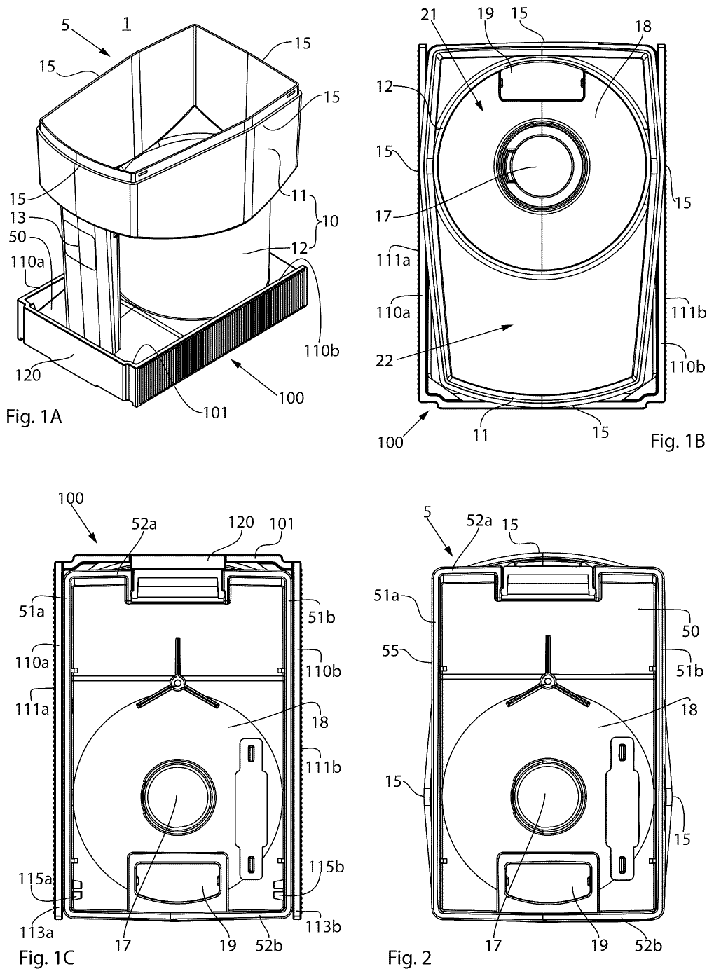

FIGS. 1A-1C show various views of the first preferred embodiment of the storage device,

FIG. 2 shows a bottom view of the storage station as part of the first preferred embodiment of the kit,

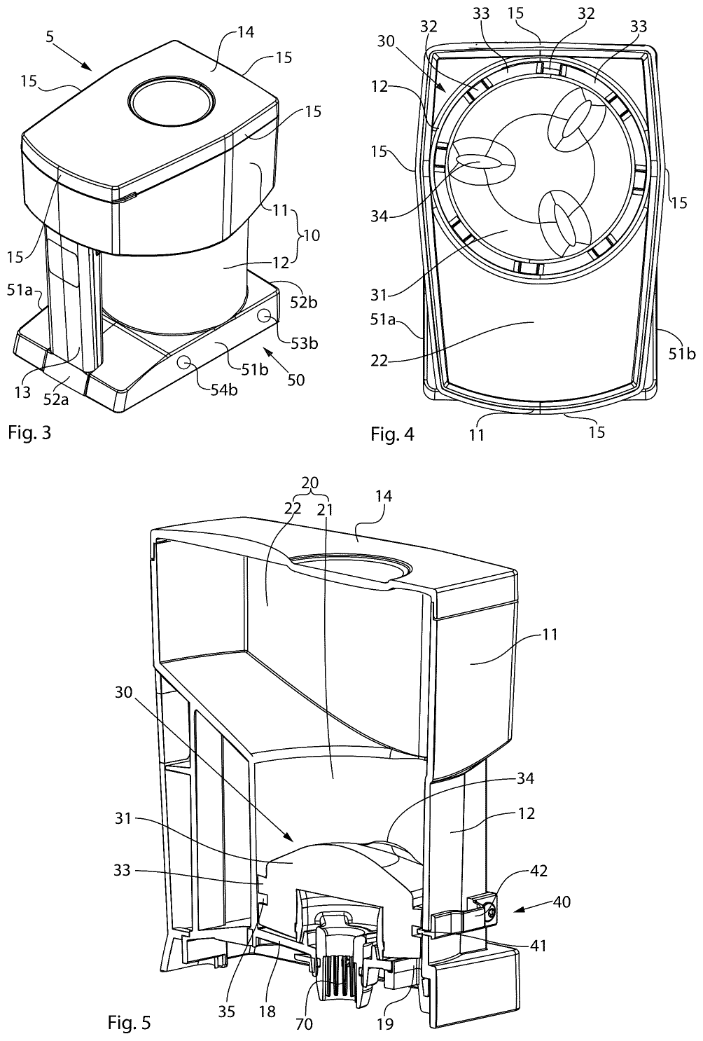

FIGS. 3-5 show various views of the storage station as part of the first preferred embodiment of the kit, wherein FIG. 3 shows an oblique view, FIG. 4 a plan view, and FIG. 5 a sectional view,

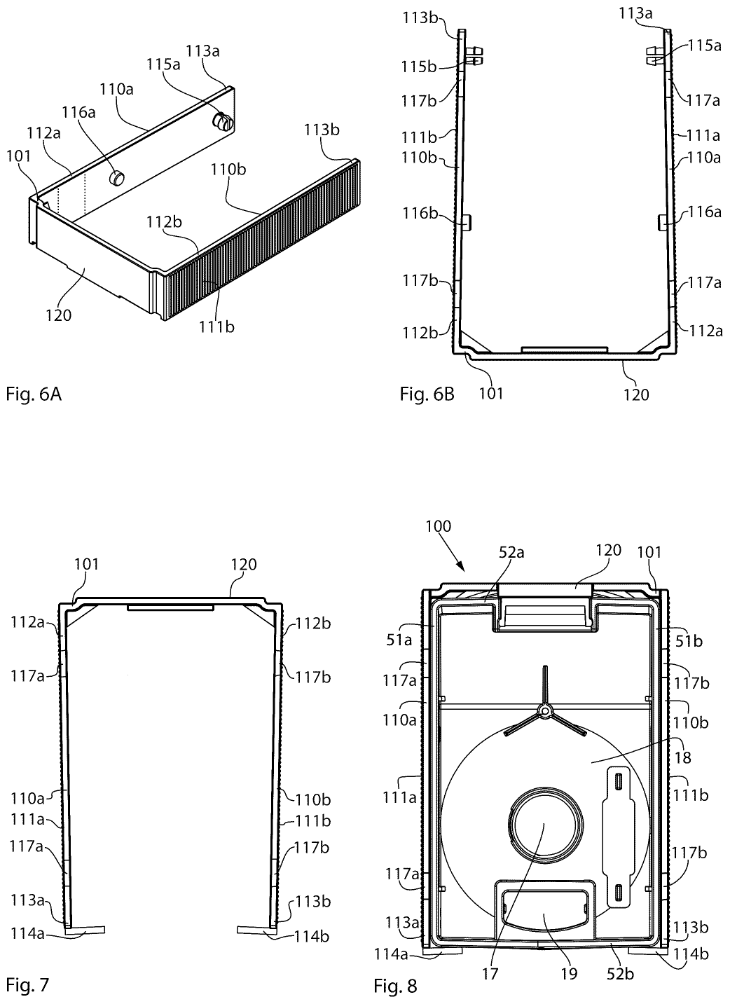

FIGS. 6A and 6B show various views of the adapter means of the first embodiment of the kit,

FIG. 7 shows a bottom view of an adapter means of the second preferred embodiment of the kit,

FIG. 8 shows a bottom view of the second preferred embodiment of the storage device,

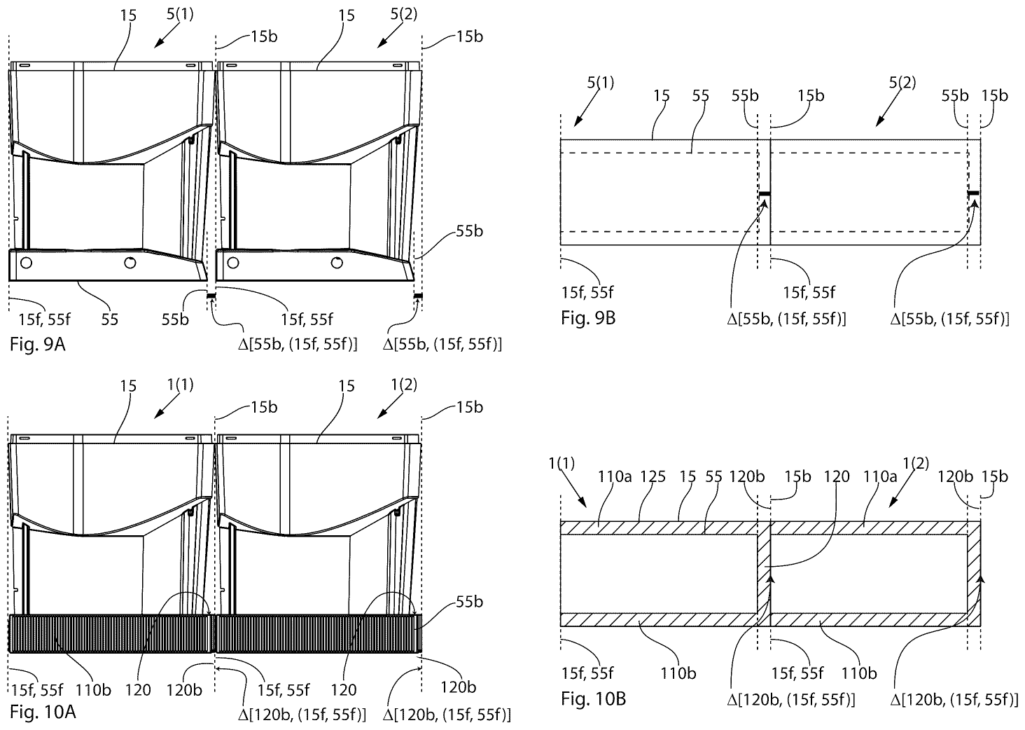

FIGS. 9A and 9B show views of two storage stations arranged one after the other according to the first embodiment of the kit, wherein FIG. 9A shows a side view and FIG. 9B shows a schematic plan view,

FIGS. 10A and 10B show views of two storage devices arranged one after the other according to the first embodiment, wherein FIG. 10A shows a side view and FIG. 10B shows a schematic plan view,

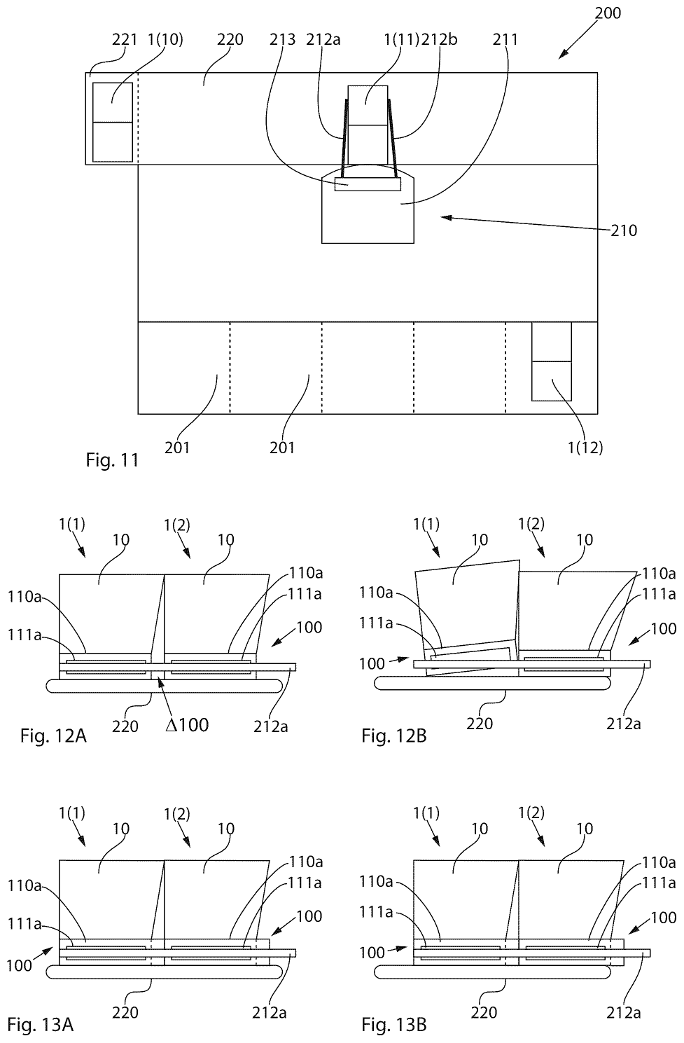

FIG. 11 shows a schematic plan view of a picking device in which the method according to the invention is operated,

FIGS. 12A and 12B show schematic side views of a method for storing a further embodiment of the storage devices according to the invention,

FIGS. 13A and 13B show schematic side views of the method according to the invention.

FIGS. 1A-1C show different views of the first preferred embodiment of the storage device 1, wherein FIG. 1A shows an oblique view, FIG. 1B a plan view, and FIG. 1C a bottom view. The storage device 1 comprises a storage station 5 and an adapter means 100. The storage station 5 comprises a housing 10 with an upper housing portion 11 and a lower housing portion 12. The housing 10 has an outer maximum housing contour 15, which in the embodiment shown is defined by the upper housing portion 11. Below the housing 10, the storage station 5 has a base structure 50, which can only be seen partially in FIG. 1A, since it is largely covered by the adapter means 100. A handle 13 extends from the base structure 50 to the upper housing portion 11. This handle simplifies the handling of the storage station 5 or the storage device 1.

In the embodiment shown, the adapter means 100 is U-shaped and comprises a base portion 101 from which two parallel contact means 110a, 110b extend. In the first embodiment shown, the base portion 101 comprises a contour compensation portion 120, the function of which has already been indicated above and is described in greater detail with reference to subsequent figures. As can be seen in FIG. 1B, the housing 10 comprises in the lower housing portion 12 a base plate 18 with a central opening 17 and a discharge opening 19. In the central opening 17, a coupling means of a separating device is arranged, which is described in greater detail with reference to a subsequent figure. In particular, in FIGS. 1B and 1C, it can be seen that each contact means 110a, 110b comprises a contact portion 111a, 111b which serves as a contact surface for the jaws of a jaw gripper.

FIG. 1C shows a bottom view of the first embodiment of the storage device. In particular, it can be seen that the base structure 50 comprises two opposite side regions 51a, 51b and two opposite end regions 52a, 52b. The contact means 110a, 110b are located on the side regions 51a, 51b, and the base portion 101 of the adapter means 100 is arranged at the end region 52a. In FIG. 1C, it can be seen that the side regions 51a, 51b of the base structure 50 are penetrated by a first fastening means 115a, 115b in their portion facing away from the base portion 101. The first fastening means 115a, 115b extend inwards from the contact means 110a, 110b of the U-shaped adapter means 100, as will be described in greater detail with reference to subsequent figures. In the embodiment shown, the side regions 51a, 51b and the end regions 52a, 52b are designed to cover the entire surface. However, this is not essential; at least parts of it can also be open. It is also conceivable that the end region 52b opposite the base portion be completely free of material.

FIG. 2 shows a bottom view of the first embodiment of the storage station 5, i.e., compared to FIG. 1C, the adapter means 100 is omitted. In FIG. 2, it can be seen that the side regions 51a, 51b and the end regions 52a, 52b define a base structure contour 55 of the base structure 50. It can also be seen that, in the embodiment shown, the outer maximum housing contour 15 of the housing 10 extends over the base structure contour 55 of the base structure 50, viz., in the side regions 51a, 51b and the end region 52a.

FIGS. 3-5 show various views of the storage station 5 as part of the first preferred embodiment of the kit (as well as the storage device), wherein FIG. 3 shows an oblique view, FIG. 4 a plan view, and FIG. 5 a sectional view. In the description of FIGS. 3-5, those components of the storage station 5 which have already been described with reference to previous figures are no longer explained in detail; however, the reference signs are included in the figures for reasons of clarity. In FIG. 3, it can be seen that the housing 10 is provided with a cover 14, which is always arranged on the housing 10 when the storage station is “in operation.” Of the base structure 50, the end region 52a and the side region 51b can be seen in particular. The side region 51b comprises a second fastening means 53b and a fourth fastening means 54b, which in the embodiment shown are designed as through-holes in the side region 51a. Fastening means of the adapter means 100 engage in these fastening means, wherein the fastening means of the adapter means are described in greater detail with reference to subsequent figures.

As can be seen in FIGS. 4 and 5, the lower housing portion 12 encloses or defines a lower circular-cylindrical receiving space portion 21 in which a separating device 30 is arranged, which in the embodiment shown has the shape of a rotor. The separating device 30 comprises a main body 31 on which a plurality of vertical webs 33 are arranged, wherein a channel 32 is defined between each two webs 33. The webs 33 or channels 32 are adapted to the small piece goods to be separated in such a way that only a certain number of small piece goods can be arranged in a defined manner in one channel. A plurality of projections 34 are arranged on the conical surface of the main body 31, which, during operation, ensure that the rotating separating device 30 moves the small piece goods such that any existing jamming is resolved, and the small piece goods are guided to the channels 32. As can be seen in FIG. 5, the separating device 30 does not extend over the entire height of the inner circular-cylindrical receiving portion 21, which is defined by the lower housing portion 12. Since the channels 32 are to be adapted to the small piece goods to be separated and their shapes, a separating device 30 can, in another embodiment (with which other small piece goods are to be separated), also extend through the entire height of the lower circular-cylindrical receiving portion 21. An upper receiving space portion 22 extends above the inner circular-cylindrical receiving portion 21. The inner circular-cylindrical receiving portion 21 and the upper receiving space portion 22 form a receiving space 20. The portion of the receiving space 20 not occupied by the separating device 30, i.e., the region above the cover surface of the separating device 30, serves for the chaotic storage of small piece goods to be separated. As already mentioned above, this storage region can vary according to the vertical extension of the separating device 30.

In FIG. 5, a coupling means 70 can be seen which extends through the central opening in the base plate 18 and couples the separating device 30 to a drive (not shown) in a dispensing station (not shown). In FIG. 5, it can also be seen that the webs 33 of the separating device 30 are divided into an upper portion and a lower portion by a horizontally extending slot 35. A retaining portion 41 of a holding device 40 is guided in the slot 35. The holding device 40 itself is fixed to the lower housing portion 12 via a fastening portion 42. The retaining portion 41 is guided into the inner circular-cylindrical receiving space portion through a slot in the lower housing portion 12. The function of the holding device 40 and in particular of the retaining portion 41 is to separate small piece goods, arranged in a channel portion defined by the upper portions of the webs, from a small piece good in the lower channel portion. This is necessary, in a channel that is rotated over the discharge opening 19, to prevent an undefined number of small piece goods from being dispensed. By retaining the retaining portion 41 in the slot 35 above the discharge opening 19, only the small piece good (or the small piece goods) arranged in the lower channel portion is/are discharged; usually, this is only one small piece good.

FIGS. 6A and 6B show various views of the adapter means 100 of the first embodiment of the kit, wherein FIG. 6A shows an oblique view, and FIG. 6B shows a bottom view. In the first embodiment, the adapter means 100 is U-shaped and comprises a base portion 101 from which two contact means 110a, 110b extend. In this embodiment, the contact means are not completely parallel, but the angle between the base portion and the contact means 110a, 110b is <90°, such that the contact means 110a, 110b converge slightly at their end portions 113a, 113b. At the end portions 113a, 113b, on each contact means 110a, 110b, a first fastening means 115a, 115b in the form of a locking lug is arranged, which protrudes into the interior of the U-shape of the adapter means 100. In the middle region, the contact means 110a, 110b in the embodiment shown further comprise a third fastening means 116a, 116b. The first and third fastening means of the adapter means 100 cooperate with the second and fourth fastening means 53a, 53b, 54a, 54b at the side regions 51a, 51b of the base structure in order to releasably fasten the adapter means 100 to the base structure 50 of the storage station 5.

In order to be able to easily bend the contact means 110a, 110b apart for the fastening process (and release), the contact means 110a, 110b each comprise an elastic clamping portion 112a, 112b. As can be seen in FIG. 6B, each contact means 110a, 110b in this embodiment comprises two sliding regions 117a, 117b, which ensure that a storage device does not cause any disturbing noises during a pulling or pushing movement, and that the pulling and pushing as such also causes less friction, so that less clamping force has to be exerted on a storage device.

On the outward-directed surfaces of the contact means 110a, 110b, contact portions 111a, 111b are arranged, at which clamping jaws of a gripper attach and via which the frictional connection between the storage device and the gripper is generated for moving the storage device. In the embodiment shown, the contact portions 111a, 111b are formed vertically, but this may vary depending upon the clamping jaws used.

FIG. 7 shows a bottom view of an adapter means 100 of the second preferred embodiment of the kit. In this embodiment, the contact means 110a, 110b do not comprise first and third fastening means; instead, elastic gripping portions 114a, 114b are arranged at the end portions 113a, 113b of the contact means 110a, 110b. As can be seen in FIG. 8, which shows a bottom view of the second preferred embodiment of the storage device, these elastic gripping portions 114a, 114b encompass portions of the end region 52b, whereby a detachable fastening of the adapter means 100 to the storage station 5 is achieved.

FIGS. 9A and 9B show views of two storage stations 5(1), 5(2), arranged one after the other, according to the first embodiment of the kit, wherein FIG. 9A shows a side view, and FIG. 9B shows a schematic plan view. The two storage stations 5(1), 5(2) are located one after the other, i.e., the end region (front) of the storage station 5(2) is directly adjacent to the back region (rear) of the storage station 5(1). The outer maximum housing contour 15 as well as the base structure contour 55 of the illustrated storage stations 5(1), 5(2) have identical front vertical contact surfaces 15f, 55f, which are indicated in FIG. 9A by vertical dashed lines. This means that the base structure 50 and the housing 10 extend the same distance to the front, so that the contours of the housing 10 and the base structure 50 are identical in their end regions in this region. In the case of rear contact surfaces 15b, 55b, however, these are not identical; rather, there is a distance D [15b, 55b] between them, as can be clearly seen in FIG. 9A. The rear contact surfaces 15b, 55b are not identical, since the housing 10 extends further rearwards in the back region of the storage station 5 than the base structure 50 does. The maximum contours of the housing 10 and the base structure 50 in this region are therefore different. Because the two storage stations are located directly behind one another and touch each other in the region of the housings, there is a gap not only between the rear contact surfaces 15b, 55b, but also between the rear contact surface 55b of the base structure contour 55 of the storage station 5(1) and the two (identical) front contact surfaces of the storage station 5(2). In FIGS. 9A and 9B, this gap is denoted by D [55b,(15f, 55f)]. Whereas the storage stations are directly adjacent to each other in the region of the housings, there is a gap between the base structures of the storage stations. In the theoretical case that storage stations arranged in this way are removed or moved with a jaw gripper, this can lead to jamming of the storage station 5(1). This jamming is explained in more detail in the following figures. In FIG. 9B, this gap is illustrated schematically, wherein the base structure contour 55 is indicated by an inner dashed line and the outer maximum housing contour 15 by an outer line. In the region of contact between the two storage stations, the gap D [55b,(15f, 55f)] is again illustrated in the lower region.

FIGS. 10A and 10B show views of two storage devices 1(1), 1(2) arranged one after the other according to the first embodiment, wherein FIG. 10A shows a side view, and FIG. 10B shows a schematic plan view. In contrast to FIG. 9B, FIG. 10A does not show the storage stations (as part of the kit), but, rather, storage devices each comprising a storage station and an adapter means. As described with reference to previous figures, each adapter means comprises two contact means 110a, 110b and, in the described embodiment, a base portion 101 and a contour compensation portion 120. According to the invention, this contour compensation portion 120 is selected such that a rear contact surface 120b to the adapter means contour 125 is identical to the rear contact surface 15b to the outer maximum housing contour 15 of the housing 10. Due to the identity of the rear contact surface 15b to the outer maximum housing contour 15 and the rear contact surface 120b to the adapter means contour 125, it follows that there is also no gap between the rear contact surface 120b to the adapter means contour 125 of the storage device 1(1) and the front contact surfaces 15f, 55f of the storage device 1(2), which has an impact on how the storage devices can be removed or moved, as described with reference to a subsequent figure. In FIG. 10B, a schematic view corresponding to FIG. 9B is shown, wherein it can be seen that the contour compensation portion 120 of the adapter means fills the space that in the embodiment according to FIGS. 9A, 9B had the gap D [55b,(15f, 55f)].

FIG. 11 shows a schematic plan view of a picking device 200 in which the method according to the invention is operated and in which the storage devices according to the invention can be stored. A corresponding picking device is disclosed, for example, in EP 3 141 497 A1, the disclosure content of which with regard to the picking device is hereby incorporated into this application. The picking device 200 comprises a plurality of horizontal storage locations 201 on which, among other things, storage devices according to the invention can be stored. The picking device further comprises a storing device 220, which is usually designed as a storage conveyor. The storing device 220 comprises a deposit region 221 which extends outwards and which serves to receive piece goods to be stored. The picking device further comprises a gripper 210, with which piece goods can be removed from the storing device 220 and fed to a horizontal storage location. In the embodiment shown, the gripper is designed as a jaw gripper, which has a deposit table 211 and two clamping jaws 212a, 212b. The clamping jaws 212a, 212b are fastened to a clamping jaw guide 213, by means of which the clamping jaws can be moved horizontally over the deposit table 211. Furthermore, the clamping jaw guide 213 serves to pivot the clamping jaws in order to grip piece goods, as indicated in FIG. 11. A further detailed description of the picking device is not provided here; reference is made to the aforementioned publication.

To carry out the method according to the invention, a storage station to be stored is first provided, wherein this has the aforementioned structural specifications. In order to ensure the storability of this storage station, according to the invention, it is to be connected to an adapter means according to the features described above, whereby a storable, grippable storage device is produced. This grippable storage device 1(10) is arranged in the deposit region 221 of the storing device 220 and is moved with the storing device in a storage direction into the storage region of the picking device (in the figure, two storage devices arranged one after the other are always shown, in order to align FIG. 11 with subsequent figures). With reference to FIG. 11, this means that the grippable storage devices 1(10) are moved to the right. Subsequently, the grippable storage devices, designated 1(11) in FIG. 11, are grasped with the gripper and moved to a horizontal storage location 201 (see in this regard storage devices 1(12)). By connecting the storage station to the adapter means, which is aimed at exactly this storage station to be stored, the storage station, which is not actually storable, becomes a storable (because it is grippable) storage device, which can be handled with a conventional picking device.

With reference to FIGS. 9A-10B, it was indicated that, when two storage stations (or two storage devices according to the invention with adapter means without contour compensation portion) are arranged one after the other, a gap is created in the lower region, which can lead to problems when these piece goods arranged one after the other are moved simultaneously. This is illustrated with reference to FIGS. 12A-13B. FIGS. 12A, 12B show a view of the method in which two storage devices 1(1), 1(2) according to the invention are arranged on a storing device 220, which are to be moved by clamping jaws of a clamping gripper of the storing device 220. In the third embodiment of the storage device according to the invention shown in FIGS. 12A, 12B, the adapter means 100 does not comprise a contour compensation portion, so that a gap is created between the adapter means 100, which for the sake of simplicity is here designated by D100. Due to this gap between the two adapter means or the gap in the lower region of the storage devices arranged one after the other, when the two storage devices are moved down from the storing device 220, the left storage device 1(1) may stand up and become wedged, so that further movement of the two storage devices is not possible or may possibly lead to damage to the storing device. However, the absence of the contour compensation portion is only relevant if moving two storage devices arranged one after the other at the same time is even being considered. If this is not the case, the provision of the contour compensation portion is superfluous, because the storage station does not attain the grippability or storage capacity through the contour compensation portion as such.

FIGS. 13A and 13B show schematic side views of the method according to the invention when using adapter means with contour compensation portion. Since no gap D100 is present, the storage device 1(1) cannot stand up during movement, and no damage to the storing device or incorrect movement of the two storage devices can occur.

1. A storage device for storage in a picking device, operated with a jaw gripper, with a plurality of horizontal storage locations, the storage device comprising:
a storage station for small piece goods, comprising:
a housing with an upper housing portion, a lower housing portion, and a base plate with a discharge opening, wherein the upper and lower housing portions define a receiving space with a lower, inner circular-cylindrical receiving space portion and an upper receiving space portion extending above it, and with a separating device, arranged in the lower circular-cylindrical receiving space portion, and a holding device, wherein the housing has an outer maximum housing contour; and
a base structure arranged below the housing and supporting the housing, with two opposite side regions and two opposite end regions in each case, wherein the side regions and the end regions together define a base structure contour; and
an adapter means with at least two contact means which are detachably arranged on the base structure and which are designed such that each contact means in the fastened state provides a contact portion adjacent to the side regions, wherein the contact portions are designed and aligned such that the contact portions can be gripped by clamping jaws of the jaw gripper.

2. The storage device claim 1, wherein the adapter means is U-shaped and has a base portion to which the two contact means are fastened.

3. The storage device of claim 2, wherein a first of the two contact means has an elastic clamping portion, and the first contact means and the at least one clamping portion are arranged and designed such that the adapter means is detachably fastened to the base structure by means of a frictional connection.

4. The storage device of claim 2, wherein a first of the two contact means has, at its end portion facing away from the base portion, an inward-facing, at least partially elastic gripping portion which is designed such that the adapter means is detachably fastened to the base structure via the base portion and the gripping portion by means of a clamping force.

5. The storage device of claim 2, wherein each of the two contact means has a first fastening means and each side region has a second fastening means, wherein the first fastening means and the second fastening means are coordinated with one another in such a way that the contact means are detachably fastened to the base structure.

6. The storage of device of claim 1, wherein the adapter means has a contour compensation portion which, in the fastened state, is arranged at an end region of the base structure and which is designed such that an adapter means contour in the region of the end regions of the base structure is vertically adapted to the maximum housing contour.

7. A kit for making a storage station for small piece goods storable in a picking device operated with a jaw gripper, comprising:
a storage station for small piece goods, comprising:
a housing with an upper housing portion, a lower housing portion, and a base plate with a discharge opening, wherein the upper and lower housing portions define a receiving space with a lower, inner circular-cylindrical receiving space portion and an upper receiving space portion extending above it, and with a separating device, arranged in the lower circular-cylindrical receiving space portion, and a holding device, wherein the housing has an outer maximum housing contour; and
a base structure arranged below the housing and supporting the housing, with two opposite side regions and two opposite end regions in each case, wherein the side regions and the end regions together define a base structure contour; and
an adapter means for releasably fastening to the base structure of the storage station, wherein the adapter means comprises two contact means each having a contact portion,
wherein the contact means are designed such that each contact means is arranged adjacent to the side regions in the fastened state, wherein the contact portions are designed such that the contact portions can be gripped by clamping jaws of a jaw gripper in the fastened state of the adapter means.

8. The kit of claim 7, wherein the adapter means is U-shaped and has a base portion to which the contact means are fastened.

9. The kit of claim 8, wherein at least one contact means has an elastic clamping portion, and the contact means and the at least one clamping portion are arranged and designed such that the adapter means can be detachably fastened to the base structure by means of a frictional connection.

10. The kit of claim 8, wherein at least one contact means has, at its end portion facing away from the base portion, an inward-facing, at least partially elastic gripping portion which is designed such that the adapter means can be detachably fastened to the base structure via the base portion and the gripping portion by means of a clamping force.

11. The kit of claim 7, wherein each contact means has a first fastening means and each side region has a second fastening means, wherein the first fastening means and the second fastening means are coordinated with one another in such a way that the contact means can be detachably fastened to the base structure.

12. The kit of claim 7, wherein the adapter means has a contour compensation portion which can be arranged at an end region of the base structure and which is designed such that an adapter means contour in the fastened state in the region of the end regions of the base structure is adapted vertically to the maximum housing contour.

13. A method for storing storage stations in a picking device with a plurality of horizontal storage locations, a storing device and a jaw gripper, the method comprising:
providing a storage station to be stored, the storage station having a housing with an outer maximum housing contour and with a base structure, arranged below the housing and supporting the housing, with two opposite side regions and two opposite end regions in each case, wherein the side regions and the end regions together define a base structure contour;
providing an adapter means with at least two contact means, wherein each contact means comprises a contact portion, wherein the adapter means is determined such that the contact means are designed such that the designated adapter means can be detachably fastened via the contact means to the base structure of the storage stations to be stored, and the contact portions can be gripped by clamping jaws of a jaw gripper;
detachably fastening the adapter means to the base structure of the storage stations to be stored, thus providing a storage device that can be gripped with the jaw gripper;
arranging the grippable storage device in a deposit region of the storing device;
moving the grippable storage device arranged in the deposit region is moved with the storing device in a storage direction;
gripping the grippable storage device with the jaw gripper at the contact portions; and
moving the grippable storage device to a horizontal storage location.
